(19) United States
(12) Patent Application Publication
(10) Pub. No.: US 2023/0197295 A1
(43) Pub. Date: Jun. 22, 2023

(54) HYDROGEN-RESISTANT COATINGS AND ASSOCIATED SYSTEMS AND METHODS

(71) Applicant: Massachusetts Institute of Technology, Cambridge, MA (US)

(72) Inventors: Bilge Yildiz, Cambridge, MA (US); Cigdem Toparli, Ankara (TR); Minh Dinh, San Francisco, CA (US)

(73) Assignee: Massachusetts Institute of Technology, Cambridge, MA (US)

(21) Appl. No.: 17/923,407

(22) PCT Filed: May 7, 2021
(86) PCT No.: PCT/US2021/031438

§ 371 Date: Nov. 4, 2022

Related U.S. Application Data
(60) Provisional application No. 63/021,587, filed on May 7, 2020.

(51) Int. Cl. G21C 3/07; C09D 1/00

(52) U.S. Cl. CPC G21C 3/07; C09D 1/00

(57) ABSTRACT

Hydrogen-resistant coatings and associated systems and methods are generally described. In some aspects, a hydrogen-resistant coating comprises a doped tin oxide comprising one or more dopants. The doped tin oxide may, in some cases, exhibit low hydrogen solubility and low hydrogen diffusivity and may therefore reduce and/or prevent permeation of hydrogen in an underlying substrate. In some embodiments, the one or more dopants comprise one or more transition metals (e.g., tungsten, molybdenum, niobium).

### RELATED APPLICATION

This application claims priority under 35 U.S.C. §119(e) to U.S. Provisional Application No. 63/021,587, filed May 7, 2020, and entitled “Hydrogen-Resistant Coatings and Associated Systems and Methods,” which is incorporated herein by reference in its entirety for all purposes.

### TECHNICAL FIELD

Hydrogen-resistant coatings and associated systems and methods are generally described.

### BACKGROUND

Permeation of hydrogen in materials such as metals and/or metal alloys can have deleterious effects in a wide range of systems, including nuclear reactors and oil and gas pipelines. Accordingly, articles, systems, and methods to reduce and/or prevent hydrogen permeation are needed.

### SUMMARY

Hydrogen-resistant coatings and associated systems and methods are generally described. The subject matter disclosed herein involves, in some cases, interrelated products, alternative solutions to a particular problem, and/or a plurality of different uses of one or more systems and/or articles.

In some aspects, an article is provided. In some embodiments, the article comprises a substrate. In some embodiments, the article comprises a coating disposed on at least a portion of the substrate. In certain embodiments, the coating comprises a doped tin oxide comprising one or more dopants.

In some aspects, a system is provided. In some embodiments, the system comprises a hollow substrate. In some embodiments, the system comprises a fuel positioned within the hollow substrate. In some embodiments, the system comprises a coating disposed on at least a portion of an inner surface and/or an outer surface of the hollow substrate. In certain embodiments, the coating comprises a doped tin oxide comprising one or more dopants.

In some embodiments, a nuclear reactor system is provided. In some embodiments, the nuclear reactor system comprises one or more fuel rods. In certain embodiments, at least one fuel rod comprises a hollow cladding comprising a metal and/or a metal alloy. In certain embodiments, at least one fuel rod comprises a fissile or fertile fuel positioned within the hollow cladding. In certain embodiments, at least one fuel rod comprises a coating disposed on at least a portion of an outer surface of the hollow cladding. In some instances, the coating comprises a doped tin oxide comprising one or more dopants. In some embodiments, the nuclear reactor system comprises a coolant in contact with at least one fuel rod.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows, according to some embodiments, a schematic illustration of an exemplary article comprising a planar substrate and a doped tin oxide coating disposed on a surface of the planar substrate;

FIG. 1B shows, according to some embodiments, a schematic illustration of an exemplary article comprising a cylindrical substrate and a doped tin oxide coating disposed on an outer surface of the cylindrical substrate;

FIG. 1C shows, according to some embodiments, a schematic illustration of an exemplary article comprising a cylindrical substrate and a doped tin oxide coating disposed on an inner surface of the cylindrical substrate;

FIG. 2 shows a cross-sectional view of an exemplary system comprising a hollow substrate, a doped tin oxide coating on at least a portion of an inner surface of the hollow substrate, and a fuel positioned within the hollow substrate, according to some embodiments;

FIG. 3 shows a cross-sectional view of an exemplary nuclear fuel rod comprising a hollow cladding, a fissile or fertile fuel positioned within the hollow cladding, and a doped tin oxide coating, according to some embodiments;

FIG. 4 shows, according to some embodiments, a schematic illustration of an exemplary nuclear reactor system comprising one or more fuel rods and a coolant in contact with at least one fuel rod;

FIG. 5 shows an exemplary plot of hydrogen concentration in doped tin oxides as a function of electron chemical potential µₑ (eV) at 600 K, 900 K, and 1200 K, according to some embodiments;

FIG. 6 shows, according to some embodiments, an exemplary plot of conductivity (S/cm) as a function of electron chemical potential µₑ (eV);

FIG. 7 shows an exemplary plot of mean square displacement (Å²) as a function of time (ns) for molybdenum-doped tin oxide, according to some embodiments;

FIG. 8 shows, according to some embodiments, an exemplary plot of hydrogen diffusivity (m²/s) as a function of 1000/T (K⁻¹); and

FIG. 9 shows an exemplary plot of hydrogen diffusivity (m²/s) as a function of 1000/T (K⁻¹) over a temperature range from room temperature to 1200 K, according to some embodiments.

### DETAILED DESCRIPTION

Hydrogen-resistant coatings and associated systems and methods are generally described. In some aspects, a hydrogen-resistant coating comprises a doped tin oxide comprising one or more dopants. The doped tin oxide may, in some cases, exhibit low hydrogen solubility and low hydrogen diffusivity and may therefore reduce and/or prevent permeation of hydrogen in an underlying substrate. In some embodiments, the one or more dopants comprise one or more transition metals (e.g., tungsten, molybdenum, niobium).

In some environments, a substrate may be exposed to hydrogen (e.g., a fluid comprising hydrogen). As an illustrative, non-limiting example, a pipeline transporting oil or natural gas may be exposed to hydrogen present in the fuel being transported (e.g., due to hydrogen-containing blends and/or dissociation of hydrocarbons) and/or in the external environment (e.g., due to acidic soil and/or water). In certain cases, the pipeline comprises a substrate comprising a metal or metal alloy (e.g., a steel), and some amount of hydrogen present in the fuel and/or external environment may permeate through at least a portion of the metal or metal alloy substrate, thereby causing mechanical degradation of the substrate (e.g., causing embrittlement). If the mechanical degradation of the substrate continues unchecked, the pipeline may ultimately crack and lead to a natural gas leak or an oil spill.

As another illustrative, non-limiting example, in a nuclear reactor, a fuel rod comprising a metal or metal alloy (e.g., a zirconium alloy) encapsulating a fissile or fertile fuel (e.g., uranium, thorium, plutonium) may be exposed to a coolant (e.g., water) at high temperatures. During operation of the nuclear reactor, hydrogen may be present in the water due to oxidative corrosion of the metal or metal alloy, radiolytic dissociation of water, and/or injection of hydrogen into the coolant to suppress radiolytic dissociation of water. In some cases, some amount of the hydrogen present in the water may enter the substrate and diffuse through the metal or metal alloy. This hydrogen permeation may result in the formation of metal hydrides within the metal or metal alloy substrate, which may mechanically weaken the metal or metal alloy substrate and cause it to become less hard and more brittle, and therefore more susceptible to cracks. Should the mechanical weakening of the metal or metal alloy substrate continue unchecked, the metal or metal alloy substrate may crack. A crack in cladding of a nuclear fuel rod may result in contamination of the coolant with nuclear fuel or fission products, which may result in severely negative consequences, including extended shutdown of the reactor and exposure of individuals to radiation. In extreme cases, cladding failure may lead to widespread core damage and even decommissioning of the entire reactor.

Surprisingly, the present inventors have determined within the context of articles, systems, and methods described herein that coatings comprising a doped tin oxide comprising one or more dopants (e.g., one or more transition metals and/or anions) may advantageously reduce and/or prevent permeation of hydrogen in an underlying substrate. Without wishing to be bound by a particular theory, doping tin oxide with one or more dopants (e.g., one or more transition metals and/or anions) may advantageously promote the formation of free electrons in the tin oxide, resulting in high electronic conductivity. This high electronic conductivity may advantageously promote removal of hydrogen via hydrogen reduction (e.g., to H₂). In some cases, doping tin oxide with one or more dopants (e.g., one or more transition metals and/or anions) may shift the electron chemical potential of tin oxide, which may lead to a change in the dominant type of hydrogen defect in the tin oxide. In certain cases, for example, hydrogen atoms in a doped tin oxide may prefer to form defect complexes with tin cation vacancies instead of remaining as interstitial defects, which may decrease hydrogen mobility in the doped tin oxide. Different types of dopants can also reduce the solubility of hydrogen in tin oxide. The inventors have found that doped tin oxides that exhibit both low hydrogen solubility and low hydrogen diffusivity may be particularly suitable for reducing and/or preventing permeation of hydrogen in an underlying substrate.

According to some aspects of the present invention, an article comprises a substrate and a coating disposed on at least a portion of the substrate. In some cases, the substrate comprises a surface of a body. The substrate (and/or the body) may have substantially any geometry.

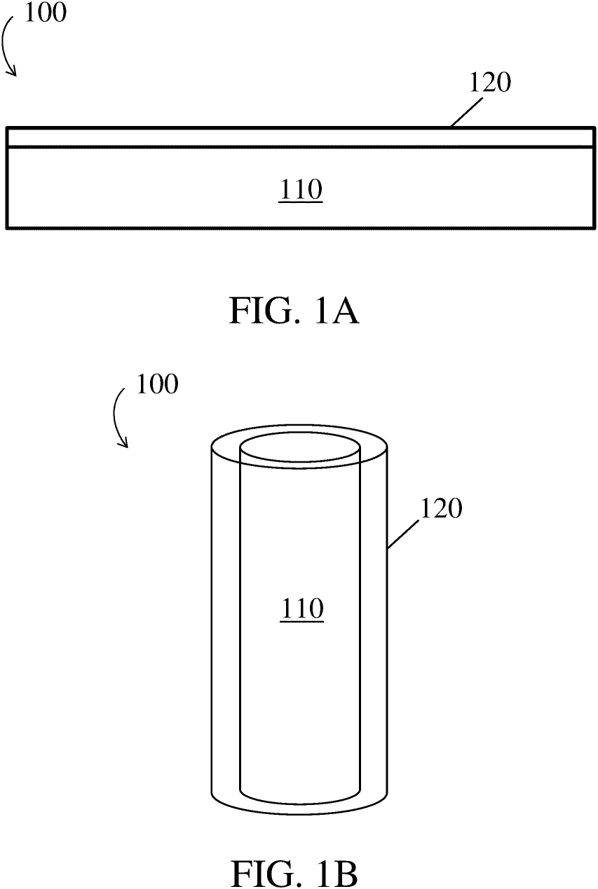

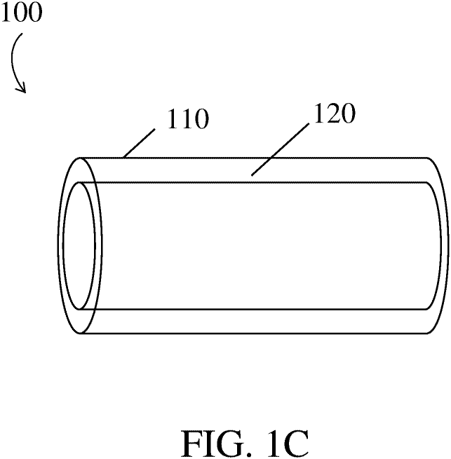

FIGS. 1A-1C each show an exemplary, non-limiting article 100 comprising substrate 110 and coating 120, where coating 120 is disposed on at least a portion of substrate 110. In some embodiments, coating 120 comprises a doped tin oxide comprising one or more dopants (e.g., one or more transition metals and/or anions). As shown in FIG. 1A, at least a portion of substrate 110 may be substantially planar. Alternatively, as shown in FIGS. 1B and 1C, at least a portion of substrate 110 may be substantially cylindrical. In FIG. 1B, coating 120 is disposed on an outer surface of cylindrical substrate 110. In FIG. 1C, coating 120 is disposed on an inner surface of cylindrical substrate 110. In certain embodiments, coating 120 may be disposed on an inner surface and an outer surface of cylindrical substrate 110.

Although substrate 110 is illustrated as being substantially planar in FIG. 1A and substantially cylindrical in FIGS. 1B and 1C, substrate 110 may be substantially spherical, substantially ellipsoidal, substantially planar, substantially cylindrical, substantially prismatic, substantially pyramidal, irregularly shaped, or any other shape. The substrate may be substantially hollow or substantially solid.

In some embodiments, the coating comprises a doped tin oxide comprising one or more dopants. Tin oxide generally refers to SnO₂. A doped tin oxide generally refers to tin oxide comprising one or more dopants. In certain embodiments, the one or more dopants comprise one or more transition metals. As used herein, a “transition metal” refers to an element in the d-block of the periodic table. The term “d-block” generally refers to those elements that have a partially filled d sub-shell (e.g., partially filled 3d, 4d, 5d, or 6d orbitals) or can give rise to cations with a partially filled d sub-shell. Examples of transition metals include, but are not limited to, scandium, titanium, vanadium, chromium, manganese, iron, cobalt, nickel, copper, zinc, yttrium, zirconium, niobium, molybdenum, technetium, ruthenium, rhodium, palladium, silver, cadmium, lutetium, hafnium, tantalum, tungsten, rhenium, osmium, iridium, and platinum. In some instances, the one or more transition metals comprise tungsten, molybdenum, and/or niobium. In some instances, the one or more transition metals comprise tungsten. In certain embodiments, the one or more dopants comprise one or more anions. A non-limiting example of a suitable anion is a fluorine anion (e.g., fluoride). The doped tin oxide may comprise any concentration of each of the one or more dopants.

In some embodiments, a doped tin oxide comprises one or more dopants having a relatively large atomic radius. Without wishing to be bound by a particular theory, a dopant having a relatively large atomic radius may advantageously act as a shallow donor and increase the concentration of cation vacancies (e.g., by staying mainly in the form of substitutional defects). In some cases, this may increase the amount of charge carriers in the tin oxide, which may accelerate hydrogen removal. In contrast, a dopant having a relatively small atomic radius may stay in both interstitial and substitutional defect forms and may act as a deep donor. Accordingly, in certain cases, one or more dopants (and, in some cases, all dopants) have a calculated atomic radius of at least 170 picometers (pm), at least 175 pm, at least 180 pm, at least 185 pm, at least 190 pm, at least 195 pm, at least 200 pm, at least 205 pm, or at least 210 ppm. In some embodiments, one or more dopants (and, in some cases, all dopants) have a calculated atomic radius in a range from 170-180 pm, 170-185 pm, 170-190 pm, 170-195 pm, 170-200 pm, 170-205 pm, 175-185 pm, 175-190 pm, 175-195 pm, 175-200 pm, 175-205 pm, 180-190 pm, 180-195 pm, 180-200 pm, 180-205 pm, 180-210 pm, 190-195 pm, 190-200 pm, 190-205 pm, 195-200 pm, 195-205 pm, or 200-205 pm. The calculated atomic radius generally refers to the atomic radii published in Clementi et al., Atomic Screening Constants from SCF Functions II: Atoms with 37 to 86 Electrons, JOURNAL of CHEMICAL PHYSICS, 47(4): 1300-07 (1967).

In some embodiments, the coating comprises a doped tin oxide having certain advantageous properties. In some cases, for example, the doped tin oxide coating has a relatively low hydrogen flux. Hydrogen flux generally refers to the amount of hydrogen transported (e.g., number of moles of atomic hydrogen) per unit time per unit area. The relatively low hydrogen flux of the doped ton oxide may, in some cases, be due at least in part to the doped tin oxide having a relatively low hydrogen diffusivity and/or a relatively low hydrogen solubility. Hydrogen diffusivity generally refers to a measure of the ability of hydrogen to move through a material via diffusion pathways. Hydrogen solubility generally refers to the concentration of hydrogen species within a material. Hydrogen flux, hydrogen diffusivity, and hydrogen solubility may be determined according to any method known in the art. As one example, hydrogen flux, hydrogen diffusivity, and hydrogen solubility may be determined using a Devanathan-Stachurski cell.

In some embodiments, the doped tin oxide coating has a lower hydrogen flux than the substrate at a given temperature. In some embodiments, the hydrogen flux of the doped tin oxide coating at a given temperature is reduced by at least about 5%, at least about 10%, at least about 15%, at least about 20%, at least about 25%, at least about 30%, or at least about 50% compared to the hydrogen flux of the substrate at the given temperature. In some embodiments, the hydrogen flux of the doped tin oxide at a given temperature is reduced compared to the hydrogen flux of the substrate at the given temperature by an amount in a range from about 5% to about 10%, about 5% to about 15%, about 5% to about 20%, about 5% to about 25%, about 5% to about 30%, about 5% to about 50%, about 10% to about 20%, about 10% to about 25%, about 10% to about 30%, about 10% to about 50%, about 15% to about 20%, about 15% to about 25%, about 15% to about 30%, about 15% to about 50%, about 20% to about 25%, about 20% to about 30%, about 20% to about 50%, about 25% to about 30%, about 25% to about 50%, or about 30% to about 50%.

In some embodiments, the doped tin oxide coating has a lower hydrogen diffusivity than the substrate at a given temperature. In some embodiments, the hydrogen diffusivity of the doped tin oxide coating at a given temperature is reduced by at least about 5%, at least about 10%, at least about 15%, at least about 20%, at least about 25%, at least about 30%, or at least about 50% compared to the hydrogen diffusivity of the substrate at the given temperature. In some embodiments, the hydrogen diffusivity of the doped tin oxide at a given temperature is reduced compared to the hydrogen diffusivity of the substrate at the given temperature by an amount in a range from about 5% to about 10%, about 5% to about 15%, about 5% to about 20%, about 5% to about 25%, about 5% to about 30%, about 5% to about 50%, about 10% to about 20%, about 10% to about 25%, about 10% to about 30%, about 10% to about 50%, about 15% to about 20%, about 15% to about 25%, about 15% to about 30%, about 15% to about 50%, about 20% to about 25%, about 20% to about 30%, about 20% to about 50%, about 25% to about 30%, about 25% to about 50%, or about 30% to about 50%.

In some embodiments, the doped tin oxide coating has a lower hydrogen solubility than the substrate at a given temperature. In some embodiments, the hydrogen solubility of the doped tin oxide coating at a given temperature is reduced by at least about 5%, at least about 10%, at least about 15%, at least about 20%, at least about 25%, at least about 30%, or at least about 50% compared to the hydrogen solubility of the substrate at the given temperature. In some embodiments, the hydrogen solubility of the doped tin oxide at a given temperature is reduced compared to the hydrogen solubility of the substrate at the given temperature by an amount in a range from about 5% to about 10%, about 5% to about 15%, about 5% to about 20%, about 5% to about 25%, about 5% to about 30%, about 5% to about 50%, about 10% to about 20%, about 10% to about 25%, about 10% to about 30%, about 10% to about 50%, about 15% to about 20%, about 15% to about 25%, about 15% to about 30%, about 15% to about 50%, about 20% to about 25%, about 20% to about 30%, about 20% to about 50%, about 25% to about 30%, about 25% to about 50%, or about 30% to about 50%.

The given temperature at which the doped tin oxide coating has a lower hydrogen flux, hydrogen diffusivity, and/or hydrogen solubility than the substrate may be any suitable temperature. In some embodiments, the given temperature is at least -50° C., at least -25° C., at least -10° C., at least 0° C., at least 10° C., at least 20° C., at least 25° C., at least 37° C., at least 50° C., at least 80° C., at least 100° C., at least 200° C., at least 300° C., at least 500° C., at least 600° C., at least 800° C., or at least 1000° C. In some embodiments, the given temperature is in a range from -50° C. to -10° C., -50° C. to 0° C., -50° C. to 10° C., -50° C. to 20° C., -50° C. to 25° C., -50° C. to 37° C., -50° C. to 50° C., -50° C. to 80° C., -50° C. to 100° C., -50° C. to 200° C., -50° C. to 300° C., -50° C. to 500° C., -50° C. to 600° C., -50° C. to 800° C., -50° C. to 1000° C., 0° C. to 10° C., 0° C. to 20° C., 0° C. to 25° C., 0° C. to 37° C., 0° C. to 50° C., 0° C. to 80° C., 0° C. to 100° C., 0° C. to 200° C., 0° C. to 300° C., 0° C. to 500° C., 0° C. to 600° C., 0° C. to 800° C., 0° C. to 1000° C., 20° C. to 25° C., 20° C. to 37° C., 20° C. to 50° C., 20° C. to 80° C., 20° C. to 100° C., 20° C. to 200° C., 20° C. to 300° C., 20° C. to 500° C., 20° C. to 600° C., 20° C. to 800° C., 20° C. to 1000° C., 37° C. to 50° C., 37° C. to 80° C., 37° C. to 100° C., 37° C. to 200° C., 37° C. to 300° C., 37° C. to 500° C., 37° C. to 600° C., 37° C. to 800° C., 37° C. to 1000° C., 50° C. to 80° C., 50° C. to 100° C., 50° C. to 200° C., 50° C. to 300° C., 50° C. to 500° C., 50° C. to 600° C., 50° C. to 800° C., 50° C. to 1000° C., 100° C. to 200° C., 100° C. to 300° C., 100° C. to 500° C., 100° C. to 600° C., 100° C. to 800° C., 100° C. to 1000° C., 300° C. to 500° C., 300° C. to 600° C., 300° C. to 800° C., 300° C. to 1000° C., or 500° C. to 1000° C. In some embodiments, the hydrogen flux, hydrogen diffusivity, and/or hydrogen solubility of the doped tin oxide may be less than the hydrogen flux, hydrogen diffusivity, and/or hydrogen solubility of the substrate (e.g., by any of the amounts disclosed above) across any of the temperature ranges disclosed herein.

In some embodiments, the doped tin oxide has a relatively high melting point. In some cases, it may be advantageous for the doped tin oxide to have a melting point that is higher than the highest temperature that the substrate will reach. In some embodiments, the doped tin oxide has a melting point of at least 600 K, at least 900 K, at least 1000 K, at least 1100 K, at least 1200 K, at least 1300 K, at least 1400 K, at least 1500 K, at least 1600 K, at least 1700 K, at least 1800 K, at least 1900 K, at least 2000 K, at least 2100 K, at least 2200 K, at least 2300 K, at least 2400 K, at least 2500 K, or at least 3000 K. In some embodiments, the doped tin oxide has a melting point in a range from 600 K to 1500 K, 600 K to 2000 K, 600 K to 2200 K, 600 K to 2500 K, 600 K to 3000 K, 900 K to 1500 K, 900 K to 2000 K, 900 K to 2200 K, 900 K to 2500 K, 900 K to 3000 K, 1000 K to 1500 K, 1000 K to 2000 K, 1000 K to 2200 K, 1000 K to 2500 K, 1000 K to 3000 K, 1500 K to 2000 K, 1500 K to 2200 K, 1500 K to 2500 K, 1500 K to 3000 K, 2000 K to 2500 K, or 2000 K to 3000 K. The melting point of the doped tin oxide may be measured according to any method known in the art. For example, melting point may be measured by differential scanning calorimetry (DSC).

In some embodiments, the coating comprising a doped tin oxide is relatively thick. In some cases, a relatively thick coating may promote hydrogen reduction. In certain cases, however, the coating is not so thick that it exceeds the epitaxial thin film limit and cracks due to thick film stresses. In some embodiments, the coating has a thickness of at least 50 nm, at least 100 nm, at least 150 nm, at least 200 nm, at least 300 nm, at least 400 nm, at least 500 nm, at least 600 nm, at least 700 nm, at least 800 nm, at least 900 nm, at least 1 µm, at least 2 µm, at least 5 µm, or at least 10 µm. In some embodiments, the coating has a thickness in a range from 50 nm to 100 nm, 50 nm to 150 nm, 50 nm to 200 nm, 50 nm to 300 nm, 50 nm to 400 nm, 50 nm to 500 nm, 50 nm to 600 nm, 50 nm to 700 nm, 50 nm to 800 nm, 50 nm to 900 nm, 50 nm to 1 µm, 50 nm to 2 µm, 50 nm to 5 µm, 50 nm to 10 µm, 100 nm to 150 nm, 100 nm to 200 nm, 100 nm to 300 nm, 100 nm to 400 nm, 100 nm to 500 nm, 100 nm to 600 nm, 100 nm to 700 nm, 100 nm to 800 nm, 100 nm to 900 nm, 100 nm to 1 µm, 100 nm to 2 µm, 100 nm to 5 µm, 100 nm to 10 µm, 200 nm to 300 nm, 200 nm to 400 nm, 200 nm to 500 nm, 200 nm to 600 nm, 200 nm to 700 nm, 200 nm to 800 nm, 200 nm to 900 nm, 200 nm to 1 µm, 200 nm to 2 µm, 200 nm to 5 µm, 200 nm to 10 µm, 300 nm to 400 nm, 300 nm to 500 nm, 300 nm to 600 nm, 300 nm to 700 nm, 300 nm to 800 nm, 300 nm to 900 nm, 300 nm to 1 µm, 300 nm to 2 µm, 300 nm to 5 µm, 300 nm to 10 µm, 400 nm to 500 nm, 400 nm to 600 nm, 400 nm to 700 nm, 400 nm to 800 nm, 400 nm to 900 nm, 400 nm to 1 µm, 400 nm to 2 µm, 400 nm to 5 µm, 400 nm to 10 µm, 500 nm to 600 nm, 500 nm to 700 nm, 500 nm to 800 nm, 500 nm to 900 nm, 500 nm to 1 µm, 500 nm to 2 µm, 500 nm to 5 µm, 500 nm to 10 µm, 600 nm to 700 nm, 600 nm to 800 nm, 600 nm to 900 nm, 600 nm to 1 µm, 600 nm to 2 µm, 600 nm to 5 µm, 600 nm to 10 µm, 700 nm to 800 nm, 700 nm to 900 nm, 700 nm to 1 µm, 700 nm to 2 µm, 700 nm to 5 µm, 700 nm to 10 µm, 800 nm to 900 nm, 800 nm to 1 µm, 800 nm to 2 µm, 800 nm to 5 µm, 800 nm to 10 µm, 900 nm to 1 µm, 900 nm to 2 µm, 900 nm to 5 µm, 900 nm to 10 µm, 1 µm to 2 µm, 1 µm to 5 µm, 1 µm to 10 µm, or 5 µm to 10 µm. Other thicknesses are also contemplated.

The doped tin oxide coating may cover any amount of the substrate. In some embodiments, the doped tin oxide coating covers at least 10%, at least 20%, at least 50%, at least 60%, at least 70%, at least 80%, at least 90%, at least 95%, at least 99%, or about 100% of the surface area of an inner surface and/or an outer surface of a substrate. In certain cases, the percentage of surface area of an inner surface and/or an outer surface of a substrate covered by the doped tin oxide coating is in a range from about 10-20%, about 10-50%, about 10-60%, about 10-70%, about 10-80%, about 10-90%, about 10-95%, about 10-100%, about 20-50%, about 20-60%, about 20-70%, about 20-80%, about 20-90%, about 20-95%, about 20-100%, about 50-60%, about 50-70%, about 50-80%, about 50-90%, about 50-95%, about 50-100%, about 60-80%, about 60-90%, about 60-100%, or about 80-100%.

The substrate may comprise any material. In some embodiments, the substrate comprises a metal and/or a metal alloy. Non-limiting examples of suitable metals include iron, nickel, zirconium, aluminum, titanium, and chromium. Non-limiting examples of suitable metal alloys include any alloy of iron, nickel, zirconium, aluminum, titanium, and/or chromium. In certain embodiments, the metal alloy comprises a zirconium alloy. Examples of suitable zirconium alloys include, but are not limited to, Zircaloy-2, Zircaloy-4, and ZIRLO, M5. In certain embodiments, the metal alloy comprises an iron alloy (e.g., FeCrAl, a steel). In some embodiments, the substrate comprises a polymer (e.g., polyethylene). In some embodiments, the substrate comprises a ceramic.

In some embodiments, the substrate comprises a single layer of a material. In certain instances, the substrate comprises a plurality of layers of one or more materials. In some such instances, the substrate comprises a first layer and a second layer disposed on the first layer. In certain cases, the first layer comprises a zirconium alloy (e.g., Zircaloy-2, Zircaloy-4, ZIRLO, M5), an iron alloy (e.g., FeCrAl, a steel), an aluminum alloy, and/or a chromium alloy. In certain cases, the second layer disposed on the first layer comprises ZrO₂, FesO₄, CrO₂, and/or AI₂O₃. In some instances, the second layer of the substrate comprises an oxidation product of a metal and/or a metal alloy of the first layer of the substrate. In certain cases, for example, a first layer of the substrate comprises a zirconium alloy (e.g., Zircaloy-2, Zircaloy-4, ZIRLO, M5), and a second layer of the substrate comprises zirconium oxide (ZrO₂).

In certain embodiments, one or more buffer layers may be positioned between the substrate and the doped tin oxide coating. In certain instances, the one or more layers positioned between the substrate and the doped tin oxide coating may enhance adhesion of the coating to the substrate, minimize thermal expansion, and/or minimize lattice strain mismatch between the doped tin oxide coating and the substrate. In certain instances, the one or more buffer layers may provide a sticky, oxide-free surface for deposition of the coating. A non-limiting example of a suitable material for the one or more buffer layers is titanium.

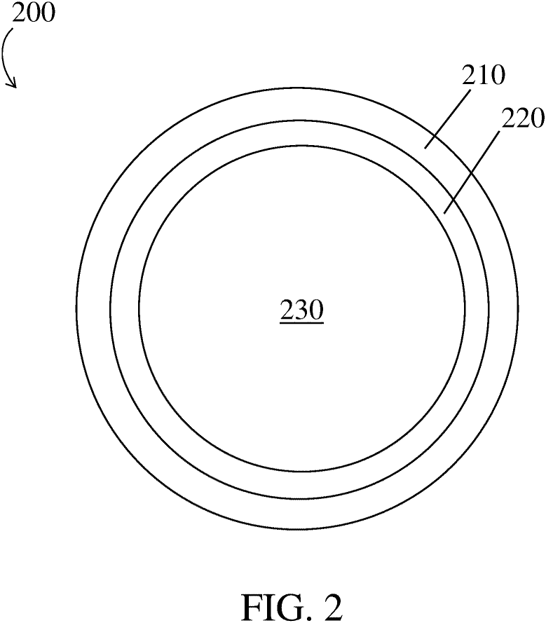

In some aspects, a system comprises a hollow substrate, a fuel positioned within the hollow substrate, and a coating disposed on at least a portion of an inner surface and/or an outer surface of the hollow substrate. FIG. 2 shows a cross-sectional view of an exemplary system. In FIG. 2, system 200 comprises hollow substrate 210. Coating 220 (i.e., a hydrogen-resistant coating) comprising a doped tin oxide is disposed on at least a portion of an inner surface of hollow substrate 210. Fuel 230 is positioned within hollow substrate 210.

In some embodiments, the system comprises a pipeline for transporting oil and/or natural gas. In certain embodiments, the fuel comprises an oil. The oil may be any petroleum-based liquid (e.g., crude oil, refined oil products). In certain embodiments, the fuel comprises a gas. The gas may be any fuel gas. In some instances, the fuel gas is a natural gas (e.g., a naturally occurring hydrocarbon gas mixture obtained from a subterranean formation). In certain cases, the fuel gas comprises a blend of natural gas and one or more additional gases. In certain cases, the fuel gas comprises hydrogen (H2). In some cases, the amount of hydrogen in the fuel gas is at least 1%, at least 2%, at least 5%, at least 10%, at least 20%, at least 50%, at least 80%, at least 90%, or about 100%. The oil and/or gas may be transported at any suitable pressure.

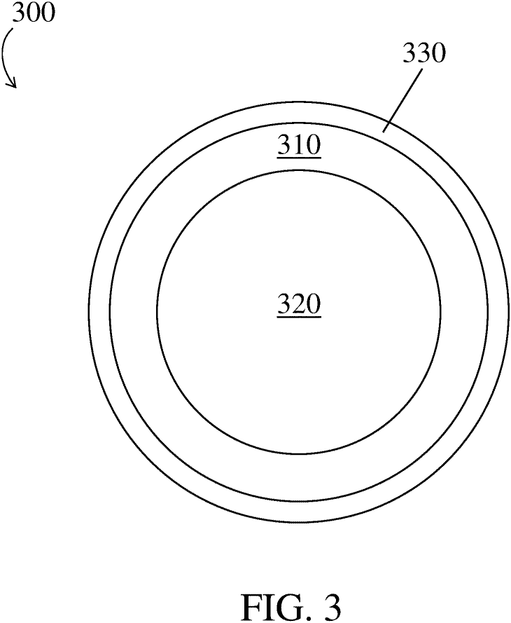

In some aspects, the system comprises a nuclear fuel rod. In some embodiments, a nuclear fuel rod comprises a hollow cladding, a fissile or fertile fuel positioned within the hollow cladding, and a coating disposed on at least a portion of an outer surface of the hollow cladding. FIG. 3 shows a cross-sectional view of an exemplary nuclear fuel rod. In FIG. 3, nuclear fuel rod 300 comprises hollow cladding 310. Fissile or fertile fuel 320 is positioned within hollow cladding 310. Coating 330 (i.e., a hydrogen-resistant coating) comprising a doped tin oxide is disposed on an outer surface of cladding 310.

As shown in FIG. 3, the nuclear fuel rod may comprise fissile or fertile fuel. The fissile or fertile fuel may, in some embodiments, comprise uranium, plutonium, and/or thorium. Fissile fuel generally refers to a material capable of sustaining nuclear fission. Non-limiting examples of suitable materials for fissile fuel include uranium-235, uranium-233, plutonium-239, and plutonium-241. Fertile fuel generally refers to a material that can be converted to fissile material through neutron absorption and subsequent nuclei conversions. Non-limiting examples of suitable materials for fertile fuel include thorium-232, uranium-234, uranium-238, plutonium-238, and plutonium-240. The fissile or fertile fuel in the nuclear fuel rod may take any suitable form. In some embodiments, the fissile or fertile fuel is in the form of pellets, powder, and/or plates.

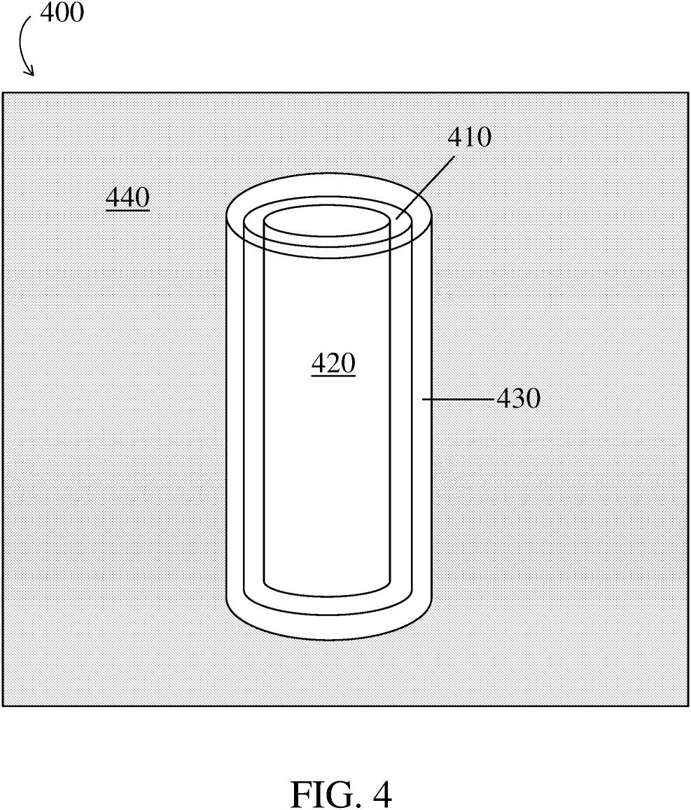

According to some embodiments, a nuclear reactor system comprises one or more fuel rods and a coolant in contact with at least one fuel rod. In some embodiments, at least one fuel rod comprises a hollow cladding comprising a metal and/or a metal alloy, a fissile or fertile fuel positioned within the hollow cladding, and a coating disposed on at least a portion of an outer surface of the hollow cladding, where the coating comprises a doped tin oxide. An exemplary nuclear reactor system is shown in FIG. 4. In FIG. 4, exemplary nuclear reactor system 400 comprises a nuclear fuel rod comprising hollow cladding 410, fissile or fertile fuel 420 positioned within hollow cladding 410, and doped tin oxide coating 430. As shown in FIG. 4, an outer surface of the fuel rod (i.e., coating 430) is in contact with coolant 440. Coolant 440 may be any suitable fluid. Non-limiting examples of suitable fluids include liquid water, deuterated water, an alcohol (e.g., ethanol, methanol, isopropanol), glycerin, carbon dioxide (e.g., liquid CO₂, supercritical CO₂), liquid ammonia, and liquid nitrogen. In certain cases, the water is distilled and/or deionized water.

In some embodiments, hydrogen may be present in the coolant. In certain instances, hydrogen may be present in the coolant due to oxidation of the metal and/or metal alloy of the cladding. In certain instances, hydrogen may be present in the coolant due to radiolytic dissociation of water. In certain instances, hydrogen may be injected during operation of the nuclear reactor in order to suppress radiolytic dissociation of water. As a result, the concentration of hydrogen in the coolant may be relatively high. In some embodiments, the concentration of dissolved hydrogen in the coolant is at least 500 mmol/m³, at least 600 mmol/m³, at least 700 mmol/m³, at least 800 mmol/m³, at least 900 mmol/m³, at least 1000 mmol/m³, at least 1100 mmol/m³, at least 1200 mmol/m³, at least 1300 mmol/m³, at least 1400 mmol/m³, or at least 1500 mmol/m³. In some embodiments, the concentration of dissolved hydrogen in the coolant is in a range from 500-800 mmol/m³, 500-1000 mmol/m³, 500-1200 mmol/m³, 500-1500 mmol/m³, 800-1000 mmol/m³, 800-1200 mmol/m³, 800-1500 mmol/m³, or 1000-1500 mmol/m³.

In certain embodiments, the nuclear reactor system is a nuclear reactor (or a portion of a nuclear reactor). The nuclear reactor may be any type of nuclear reactor. Examples of suitable nuclear reactors include, but are not limited to, pressurized water reactors (PWRs), boiling water reactors (BWRs), light water reactors (LWRs), pressurized heavy water reactors, gas-cooled reactors, fast breeder reactors, small modular reactors, and pebble bed reactors.

In some embodiments, a material of a coating and/or a substrate is substantially resistant to radiation (i.e., it retains its properties upon exposure to radiation in a nuclear reactor). In certain cases, for example, a material of a coating and/or a substrate is resistant to radiolysis under operating conditions of a nuclear reactor. In some instances, a material of a coating and/or a substrate is substantially resistant to corrosion.

According to some embodiments, a method comprises depositing a coating (e.g., a coating comprising a doped tin oxide) on a substrate. The coating may be deposited on at least a portion of the substrate by any deposition method known in the art. Non-limiting examples of suitable deposition methods include sputtering, electron beam evaporation, thermal evaporation, filtered cathodic vacuum arc (FCVA) deposition, chemical vapor deposition (CVD), pulsed laser deposition (PLD), atomic layer deposition (ALD), molecular beam epitaxy (MBE), cold spray, weld overlay, diffusion bonding, surface reaction (e.g., carburization, boronization, nitrogenation), reactive PVD, reactive CVD, electron beam induced breakdown deposition, layer-by-layer deposition, sol-gel coating, chemical plating, electroplating, “pickling,” nitriding, spin coating, and melt coating. Other deposition methods may also be used.

### Example 1

In this Example, hydrogen solubility in doped tin oxides was determined by density functional theory (DFT).

DFT calculations were conducted using the generalized gradient approximation (GGA) and projector augmented wave potentials as implemented in the Vienna Ab Initio Simulation Package (VASP). In this approach, the tin (Sn) 4d electrons were explicitly included in the valence, and a plane wave basis set was used. Specifically, 14 valence electrons were used for zirconium, and 6 for oxygen, with a plane-wave cutoff energy of 480 eV. The tin oxide systems—both defect-free and defect-containing—each consisted of 96 atoms, corresponding to 32 formula units. All calculations were performed at the theoretical equilibrium lattice parameters of the perfect rutile structure, which were within 1% of the experimental values. The Monkhorst and Pack scheme of k-point sampling was used for integration over the Brillouin zone. The grids for the k-point sampling were of the dimensions 4×4×4, which resulted in an energy value that differed by less than 5 meV per formula unit in comparison to that gained from employing a 10×10×10 k-point sampling grid. The structure optimization was set to perform until the stress of the supercell was smaller than 1 kbar and the forces on the ions were less than 10⁻² eV/Å². In order to compensate for GGA underestimating the binding energy of d states, which may lead to underestimation of the bandgap, on-site Coulomb correlation interaction, as given by the GGA+U method, was employed to improve the description of semi core states. This indirectly affected the Sn d -O p coupling and the Sn s states and led to more reasonable band gaps. The U value of 4.0 eV for Sn d states was chosen so that the resulting structure parameters, a = b =4.750 Å and c =3.183 Å, were within a reasonable range from experimental findings (a = b =4.731 Å and c =3.189 Å). The calculated band gap using GGA+U was 1.65 eV compared to the experimental value of 3.60 eV. The experimental value of 3.60 eV was used to calculate charge carrier density from the results of density of states (DOS) calculations.

Native defects, hydrogen defects, and doping element defects at interstitial and substitutional sites in tin oxides were considered. Equilibrium was found by systematically searching for the lowest-energy sites for each defect. For each defect, multiple charge states were considered.

Fifteen different elements were used as dopants in tin oxide: cobalt, zinc, rhodium, copper, nickel, manganese, chromium, palladium, titanium, zirconium, vanadium, molybdenum, niobium, tungsten, and fluorine. Each element was doped at a concentration of 100 ppm and 10000 ppm, with the concentration controlled mathematically via the dopant’s chemical potential. 100 ppm results were achieved by extrapolating results from 10,000 ppm while balancing the concentration of compensating defects by changing the electron chemical potential.

It was found that doping elements having a smaller atomic radius tended to stay in both institutional and cation substitutional forms, becoming deep donors. In contrast, doping elements having a larger atomic radius tended to stay mainly in the form of cation substitutions. If the doping element could be stabilized at a high oxidation state, it became a shallow donor. The highest stable oxidation state observed was 5⁺ for the cases of Mo-doped, W-doped, and Nb-doped tin oxides. In the oxygen-poor region, positively-charged substitutional doping defects were compensated by free electrons and negatively-charged substitutional doping defects. Hydrogen stayed in both the forms of hydrogen-oxygen vacancy defect complexes and interstitial defects. In the oxygen-rich region, the stabilization of positively-charged substitutional defects was compensated by an increase in the concentration of tin cation vacancies. This shift in defect equilibrium led to the stabilization of the hydrogen-tin vacancy defect complex, making it the most dominant hydrogen-related defect in this regime.

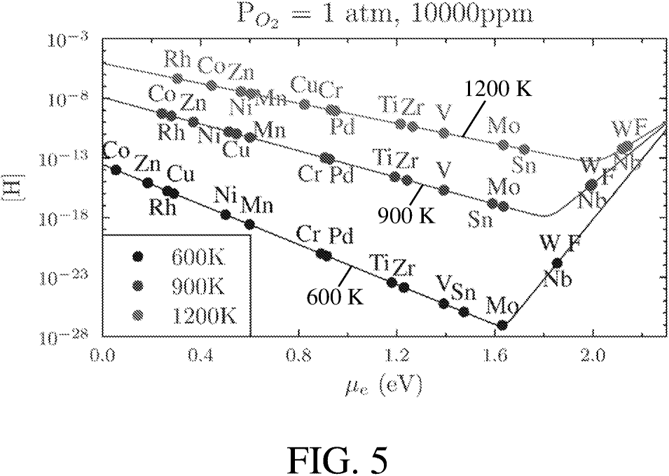

Hydrogen solubility in tin oxide was calculated as the sum of the concentrations of all hydrogen defects, which were obtained from the free energy of formation of these defects at an oxygen partial pressure of 1 atm and at temperatures of 600 K, 900 K, and 1200 K. The results are shown in FIG. 5. FIG. 5 shows a valley-shaped relationship between hydrogen solubility (vertical axis, expressed in mole fraction) and electron chemical potential (horizontal axis, eV) of doped tin oxides. This valley-shaped relationship was the result of the transition between two dominant form of hydrogen defects.

Along the horizontal axis, the electron chemical potential of the system increased, increasing the system’s carrier concentration. The total electronic conductivity was calculated as the sum of the products of the charge carriers’ concentrations and their respective mobility, as shown in Equation 1:

$$σ = e \left(n {μ}_{e} + p {μ}_{h}\right)$$

In doped-tin oxides, due to their flat valence band edges and their parabolic-like conduction band edges, holes are significantly less mobile than electrons; therefore, the doped tin oxide systems’ electronic conductivity was mainly contributed by electrons and was directly proportional to electron concentration by constants of electron mobility and electron elementary charge. In this Example, electron mobility was approximated to be constant at 106 cm² V⁻¹ s⁻¹.

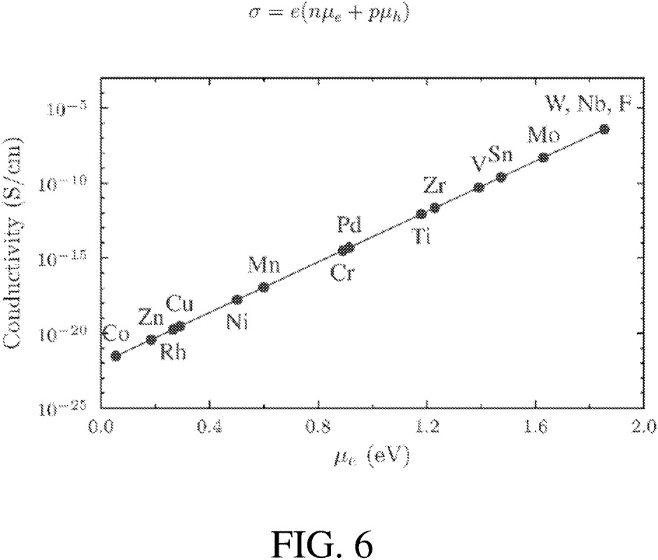

The dependence of the doped systems’ electronic conductivity on its doping composition was found and plotted in FIG. 6. From FIG. 6, it can be seen that towards the shallow doping region, higher electronic conductivity occurred due to an increase in electron concentration. The increase in the tin oxides’ electronic conductivity would also be expected to accelerate the hydrogen removal process on its surface, making them promising hydrogen barrier candidates.

Along the vertical axis, a lower hydrogen solubility was connected to fewer hydrogen defects in the system at equilibrium. This relationship found between hydrogen solubility and electron chemical potential suggested two strategies to engineer a tin oxide to be a hydrogen blocking material: one could use a dopant that would result in the structure’s Fermi level at the bottom of the valley to decrease the total amount of hydrogen concentrations, or one could use a shallow donor to maximize the amount of charge carriers in the system, which, in turn, would accelerate the hydrogen removal process. It was concluded that Mo-, W-, Nb-, and F-doped tin oxides were particularly promising in terms of ability to reduce hydrogen solubility.

### Example 2

In this Example, hydrogen diffusivities of 8 transition-metal-doped tin oxides— tungsten-doped tin oxide, molybdenum-doped tin oxide, niobium-doped tin oxide, zinc-doped tin oxide, manganese-doped tin oxide, nickel-doped tin oxide, palladium-doped tin oxide, and zirconium-doped tin oxide—were determined by DFT coupled with kinetic Monte Carlo (kMC). kMC is a probabilistic atomic simulation that transforms transition probabilities to transition rate. In this Example, the transition probability was directly related to the activation barrier calculated from DFT, and the transition rate was the diffusion rate that was solved for.

The kMC simulation started by generating a randomized and controlled initial configuration, which was informed by the DFT results (e.g., the defect equilibrium results specifying the composition and concentration of native and non-native defects) obtained in Example 1. All of the possible atoms of the diffusing species were identified spatially, and their surroundings were mapped to identify all the possible pathways that each of the atoms could take. Each possibility was called a process and contained information about the specific diffusing atom, diffusing direction and length, and its diffusing possibility. By randomly picking different processes, each of which corresponded to a possible diffusion pathway embedded with its activation energy as the transition probability, kMC simulated a realistic environment for a species to diffuse through a matrix. Once a process was picked, the species was moved along the associated pathway.

The displacement of the species and the time it took to complete the displacement were tracked for each process to calculate mean square displacement and total simulation time. These entities are then used to calculate the species’ effective diffusivity, according to Equation 2:

$$D = \frac{< {\left(Δ r\right)}^{2} >}{6 t}$$

where < (Δr)² > is the mean squared displacement of all the diffusing atoms and t is the total time that the species spent diffusing in the kMC simulation.

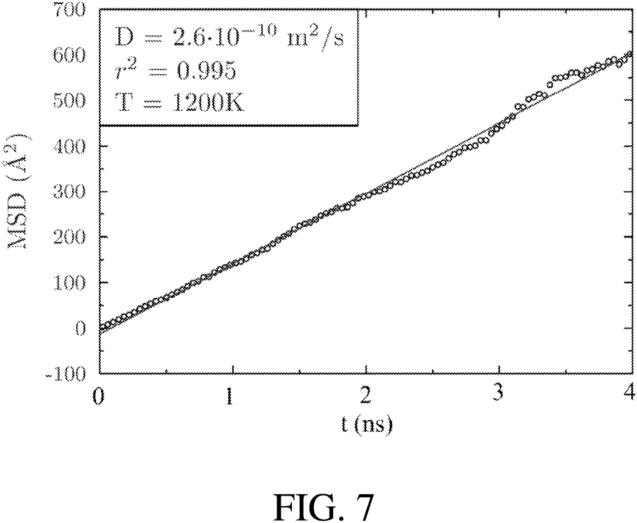

FIG. 7 shows an example in Mo-doped tin oxide of how mean square displacement and total simulation time were used to calculate hydrogen diffusivity. A linear regression of all the data points, which were collected at each kMC simulation step, was performed. The slope of this regressed line was directly proportional to hydrogen diffusivity by a constant.

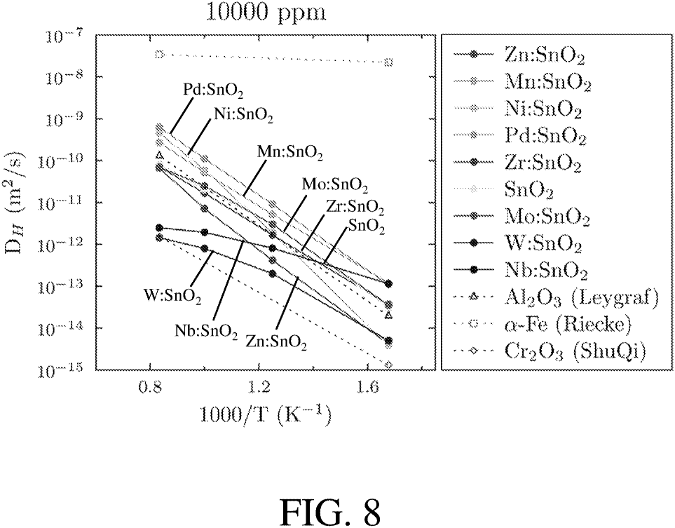

Using this technique, hydrogen diffusivity in different doped-tin oxides was calculated. By repeating the kMC simulations multiple times with initial randomized configurations, most of the systematic errors due to the lack of diversity in the super structure’s landscape were eliminated. Changing the system temperature allowed the dependence of hydrogen diffusivity on temperature in different doped tin oxides to be observed. FIG. 8 shows the dependence of hydrogen diffusivity in 8 different types of doped tin oxides across temperatures ranging from 600 K to 1200 K. As a comparison, FIG. 8 also shows hydrogen diffusivity in A1₂O₃, α-Fe, and Cr₂O₃ based on values in the literature.

The results shown in FIG. 8 demonstrate that all the doped tin oxides possessed low hydrogen diffusivities, making them good candidates to impede hydrogen diffusion. Mo-, W-, and Nb-doped SnO₂, which were previously predicted to reduce hydrogen solubility and promote hydrogen removal, were found to have even lower hydrogen diffusivity compared to that of alumina across the range of temperatures. More specifically, W-doped tin oxide outperformed Mo-doped and Nb-doped tin oxides across the simulated temperature range.

Some explanations for this result were obtained by looking at the mechanism by which doped tin oxides interact with hydrogen. At low temperature, the hydrogen diffusion barrier in tin oxides generally depended on how substitutional defects affect hydrogen hopping. Tungsten substitutional defects in tin oxide were found to be a hydrogen blocker; they impeded any hydrogen movements in their vicinity. At high temperature, the hydrogen diffusion barrier generally depended on how cation vacancies slow down H hopping. According to the results in defect equilibrium in W-doped tin oxide, tungsten acted as a shallow donor and increased the concentration of cation vacancies substantially. These two reasons combined led to W-doped tin oxide being expected to perform well as a hydrogen blocker across all temperature ranges.

### Example 3

In this Example, coatings comprising tungsten-doped tin oxide, molybdenum-doped tin oxide, and niobium-doped tin oxide were fabricated and tested experimentally using a Devanathan-Stachurski cell (DS cell).

In the experiments, a thin metal membrane was sandwiched between two independent electrochemical cells. Hydrogen was introduced into the metal membrane on one side, and atomic hydrogen which diffused through the metal was oxidized on the other side. Because small currents can be accurately measured, this resulted in a sensitive and accurate method of determining the hydrogen flux as a function of time. The mathematics of diffusion had previously been applied and verified to work with the DS cell, and these techniques have been used to calculate diffusion coefficients, hydrogen solubility, and parameters associated with hydrogen trapping.

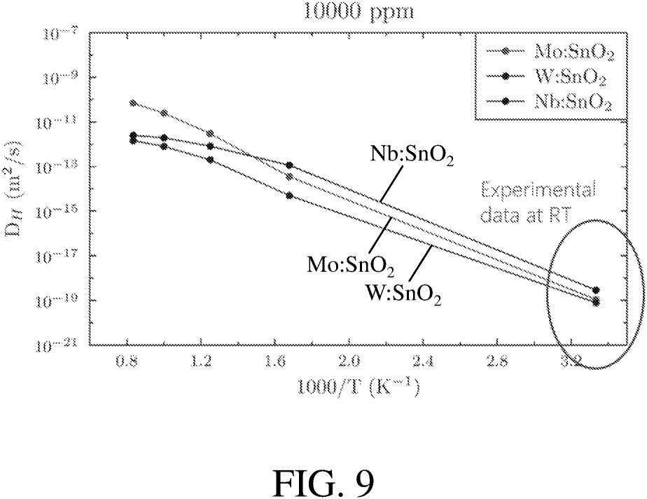

The experimental results at room temperature are shown in FIG. 9. In FIG. 9, it can be seen that the experimental results showed good agreement with predicted diffusivities from DFT and kMC. These experimental results were within an order of magnitude error from extrapolating high-temperature computational data to room temperature. The results also confirmed W-doped tin oxides’ exceptional abilities to block hydrogen diffusion at all temperature ranges.

Various inventive concepts may be embodied as one or more processes, of which examples have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

The terms “approximately,” “substantially,” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. An article, comprising:
a substrate; and
a coating disposed on at least a portion of the substrate, wherein the coating comprises a doped tin oxide comprising one or more dopants.

2. The article according to claim 1, wherein the one or more dopants comprise one or more transition metals.

3. The article according to claim 2, wherein the one or more transition metals comprise tungsten, molybdenum, niobium, cobalt, zinc, rhodium, copper, nickel, manganese, chromium, palladium, titanium, zirconium, and/or vanadium.

4. The article according to claim 3, wherein the one or more transition metals comprise tungsten, molybdenum, and/or niobium.

5. The article according to claim 4, wherein the one or more transition metals comprise tungsten.

6. The article according to claim 1, wherein the one or more dopants comprise one or more anions.

7. The article according to claim 6, wherein the one or more anions comprise fluorine.

8. The article according to claim 1, wherein the substrate comprises a metal and/or a metal alloy.

9. The article according to claim 8, wherein the metal alloy comprises a steel.

10. The article according to claim 8, wherein the metal alloy comprises a zirconium alloy.

11. The article according to claim 9, wherein the zirconium alloy is Zircaloy-2, Zircaloy-4, ZIRLO, or M5.

12. A system, comprising:
a hollow substrate;
a fuel positioned within the hollow substrate; and
a coating disposed on at least a portion of an inner surface and/or an outer surface of the hollow substrate, wherein the coating comprises a doped tin oxide comprising one or more dopants.

13. The system according to claim 12, wherein the one or more dopants comprise one or more transition metals.

14. The system according to claim 13, wherein the one or more transition metals comprise tungsten, molybdenum, niobium, cobalt, zinc, rhodium, copper, nickel, manganese, chromium, palladium, titanium, zirconium, and/or vanadium.

15. The system according to claim 14, wherein the one or more transition metals comprise tungsten, molybdenum, and/or niobium.

16. The system according to claim 15, wherein the one or more transition metals comprise tungsten.

17. The system according to claim 12, wherein the hollow substrate comprises a metal and/or a metal alloy.

18. The system according to claim 17, wherein the metal alloy comprises a steel.

19. The system according to claim 17, wherein the metal alloy comprises a zirconium alloy.

20. The system according to claim 19, wherein the zirconium alloy is Zircaloy-2, Zircaloy-4, ZIRLO, or M5.

21. The system according to claim 12, wherein the fuel comprises oil or a natural gas.

22. The system according to claim 12, wherein the fuel is a fissile or fertile fuel comprising uranium, plutonium, and/or thorium.

23. A nuclear reactor system, comprising:
one or more fuel rods, wherein at least one fuel rod comprises:
a hollow cladding comprising a metal and/or a metal alloy;
a fissile or fertile fuel positioned within the hollow cladding; and
a coating disposed on at least a portion of an outer surface of the hollow cladding, wherein the coating comprises a doped tin oxide comprising one or more dopants; and
a coolant in contact with at least one fuel rod.

24. The nuclear reactor system according to claim 23, wherein the one or more dopants comprise one or more transition metals.

25. The nuclear reactor system according to claim 24, wherein the one or more transition metals comprise tungsten.

26. The nuclear reactor system according to claim 23, wherein the metal alloy comprises a zirconium alloy.

27. The nuclear reactor system according to claim 26, wherein the zirconium alloy is Zircaloy-2, Zircaloy-4, ZIRLO, or M5.

28. The nuclear reactor system according to claim 23, wherein the fissile or fertile fuel comprises uranium, plutonium, and/or thorium.

29. The nuclear reactor system according to claim 23, wherein the coolant comprises water.
